(19) United States
(12) Patent Application Publication
(10) Pub. No.: US 2008/0222625 A1
(43) Pub. Date: Sep. 11, 2008

(54) SMART CONTACT LIST

(76) Inventors: David Elliot Goldfarb, Bet Shemesh (IL); Jonathan William Medved, Jerusalem (IL)

Correspondence Address: DANIEL J SWIRSKY, 55 REUVEN ST., BEIT SHEMESH, 99544, IL

(21) Appl. No.: 12/043,974

(22) Filed: Mar. 7, 2008

Related U.S. Application Data
(60) Provisional application No. 60/893,647, filed on Mar. 8, 2007.
(60) Provisional application No. 60/917,702, filed on May 14, 2007.

(51) Int. Cl. G06F 9/44

(52) U.S. Cl. 717/168

(57) ABSTRACT

An application for a mobile communications device includes a contact list application providing contact list operations for contact details of at least one contact, the contact details including at least one instance of updatable contact data associated with the contact, and an updater updating the updatable contact data from an external update source specified in the updatable contact data. A contact list update method includes, for each contact having an updatable contact detail, accessing an update source specified in the updatable contact detail, receiving at least one of the updated versions from the update source, and assigning the updated version to the contact. A mobile communication device includes a contact list application displaying a media clip upon communication with an entity listed as part of the contact details of a contact and an updater updating the media clip from an external update source specified as part of the contact details.

### CROSS-REFERENCE TO RELATED APPLICATIONS

This application claims benefit from U.S. Provisional Patent Application No. 60/893,647, filed Mar. 8, 2007, and U.S. Provisional Patent Application No. 60/917,702, filed May 14, 2007, both of which are hereby incorporated in their entirety by reference.

### FIELD OF THE INVENTION

The present invention relates to contact lists for mobile communications devices generally and to their maintenance and operation in particular.

### BACKGROUND OF THE INVENTION

Contact lists for mobile communications devices are known in the art. Contact lists are software applications that are typically provided with a mobile communications device to facilitate calls and other means of communication between a mobile device user and/her contacts. FIG. 1, to which reference is now made, shows a typical such mobile communications device 100. Device 100 typically comprises a phone application 50. Some devices 100 also comprise an email client 60 and/or an instant messaging (IM) client 70. Each of these communications applications typically interfaces with a contact list 5 to lookup and/or store information for the contacts with whom the user of device 100 communicates. Contact list 5 typically stores this information in contacts database 6.

FIG. 2, to which reference is now made, illustrates the contents of a typical contact list 5 as stored in contacts database 6. Contact list 5 comprises a list of contacts 10. For every contact 10 there is associated data 20. Associated data 20 typically includes one or more phone numbers to be used in conjunction with phone application 50. Depending on the sophistication of the associated communications device, an email address or/and an IM address may also be provided for use with email and IM clients 60 and 70 respectively.

Phone application 50 may access contact list 5 to look up contacts and/or their associated numbers to place an outgoing call. Application 50 may also access contact list 5 to identify an incoming caller by looking up a phone number provided by a caller-id functionality. Clients 60 and 70 may interact with contact list 5 in a similar manner.

On some phones, contact list 5 may also include an indication of a ringtone or video ringtone to play when the associated contact calls device 100. This indication typically consists of the directory and filename associated with a media file stored on device 100. Phone application 50 may use this indication to launch a media player (not shown) to play the indicated media file instead of “ringing” device 100 when the contact calls.

Contact list 5 also typically stores other data regarding contact 10. Such data typically includes personal or descriptive information, for example, a title or street address. This data may typically also be accessed by other applications on device 100.

### SUMMARY OF THE PRESENT INVENTION

An object of the present invention is to improve upon the prior art.

There is therefore provided, in accordance with a preferred embodiment of the present invention, an application for a mobile communications device including a contact list application to provide contact list operations for contact details of at least one contact, wherein the contact details include at least one instance of updatable contact data associated with the at least one contact, and an updater to update the updatable contact data from an external update source specified in the updatable contact data.

Further, in accordance with a preferred embodiment of the present invention, the contact details include at least one indication of the update source. The indication may be a uniform resource locator (URL) or it might be a web services request.

Still further, in accordance with a preferred embodiment of the present invention, the indication is a uniform resource locator (URL).

Additionally, in accordance with a preferred embodiment of the present invention, the indication indicates a web services request.

Moreover, in accordance with a preferred embodiment of the present invention, the indication points to an updated version of said updatable contact data.

Further, in accordance with a preferred embodiment of the present invention, the indication points to a contact update application to determine an appropriate new version of the updatable contact data to download to the mobile device.

Still further, in accordance with a preferred embodiment of the present invention, the updater includes means to send identifying parameters to the contact update application.

Additionally, in accordance with a preferred embodiment of the present invention, the identifying parameters include at least one indicator of the contact and a user of the device.

Moreover, in accordance with a preferred embodiment of the present invention, the identifying parameters include at least one indicator of event context.

Further, in accordance with a preferred embodiment of the present invention, the update source is associated with at least one of: the contact, a group of said contacts, and all of the contacts in the contact list.

Still further, in accordance with a preferred embodiment of the present invention, the updater also includes an update rule checker to check an update rule of each of the contact details, wherein the update rule indicates when to update said at least one updatable item.

Additionally, in accordance with a preferred embodiment of the present invention, the update rule is associated with the contact, a group of contacts, or all of the contacts in the contact list.

Moreover, in accordance with a preferred embodiment of the present invention, the indication indicates an RSS (Really Simple Syndication) feed.

Further, in accordance with a preferred embodiment of the present invention, the updatable contact data is shared media content selected by a buddy of a user of said device, wherein the at least one contact represents the buddy.

There is also provided, in accordance with a preferred embodiment of the present invention, a contact list update method including: for each contact having an updatable contact detail, accessing an update source specified in the updatable contact detail, receiving at least one of the updated versions from the update source, and assigning the updated version to the contact.

Further, in accordance with a preferred embodiment of the present invention, the update source is associated with a specific contact.

Still further, in accordance with a preferred embodiment of the present invention, the update source is associated with a group of contacts or all the contacts in the contact list.

Additionally, in accordance with a preferred embodiment of the present invention, the update source is associated with a specific event context.

Moreover, in accordance with a preferred embodiment of the present invention, the method also includes providing an update rule to determine a periodicity for the accessing.

Further, in accordance with a preferred embodiment of the present invention, the providing is associated with a specific contact.

Still further, in accordance with a preferred embodiment of the present invention, the providing is associated with a group of contacts or all the contacts in the contact list.

Additionally, in accordance with a preferred embodiment of the present invention, the update rule is associated with a specific event context.

Moreover, in accordance with a preferred embodiment of the present invention, the accessing includes accessing a URL for the update source.

Alternatively, in accordance with a preferred embodiment of the present invention, the accessing includes activating a web services request for said update source.

Further, in accordance with a preferred embodiment of the present invention, the accessing includes activating a web services request for the update source.

Still further, in accordance with a preferred embodiment of the present invention, the method accessing includes accessing an RSS feed for the update source.

There is also provided, in accordance with a preferred embodiment of the present invention, a mobile communication device including a contact list application at least to display a media clip upon communication with an entity listed as part of the contact details of a contact and an updater to update the media clip from an external update source specified as part of the contact details.

Further, in accordance with a preferred embodiment of the present invention, the external update source is a community server to enable a buddy of a user of the device to select shared media content for the user, wherein the at least one contact represents the buddy.

Still further, in accordance with a preferred embodiment of the present invention, the updater also includes an update rule checker to check an update rule for each contact, wherein the update rule indicates when to update the media clip.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of typical mobile communications device;

FIG. 2 is a schematic illustration of a typical contact list located on the device of FIG. 1;

FIG. 3 is a schematic illustration of smart contact list application and its operation, constructed and operative in accordance with a preferred embodiment of the present invention; and

FIG. 4 is a schematic illustration of a smart contact list useful with the smart contact list application of FIG. 3.

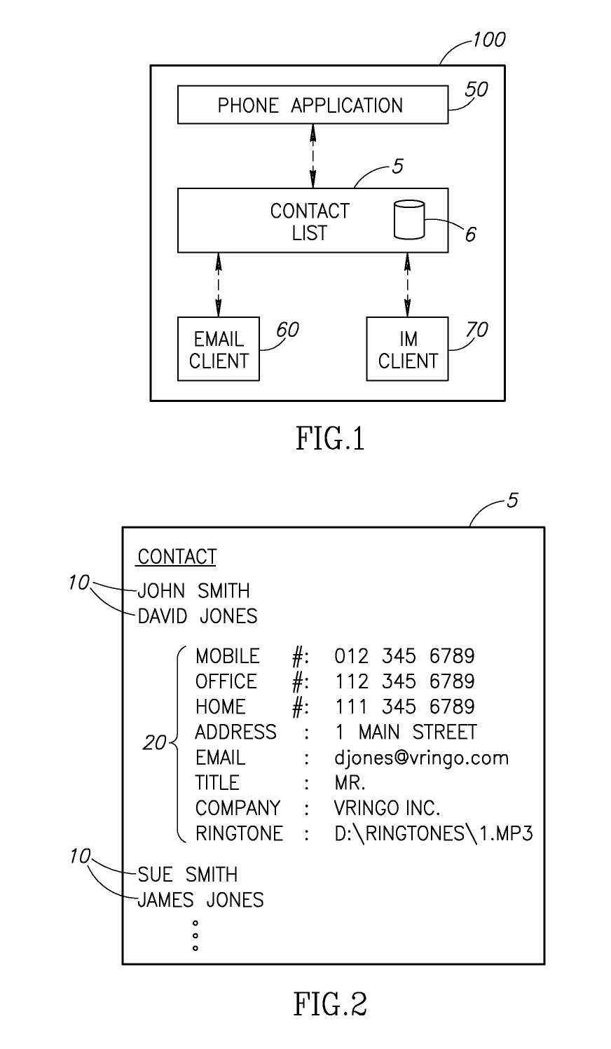

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

There may be multiple options for entering and maintaining contact list data. A user may use a keypad on device 100 to input and/or modify the data. The data may also be accessed and modified by another application on device 100. For example, a user may copy caller-id information from phone application 50 and paste it into contact list 5. Contact list 5 may also be updated by synchronizing it with an external contact list such as the address book provided with Microsoft Outlook from Microsoft Corporation in the United States. Such synchronization may be provided by ActiveSync from Microsoft Corporation or by SyncML from the Open Mobile Alliance.

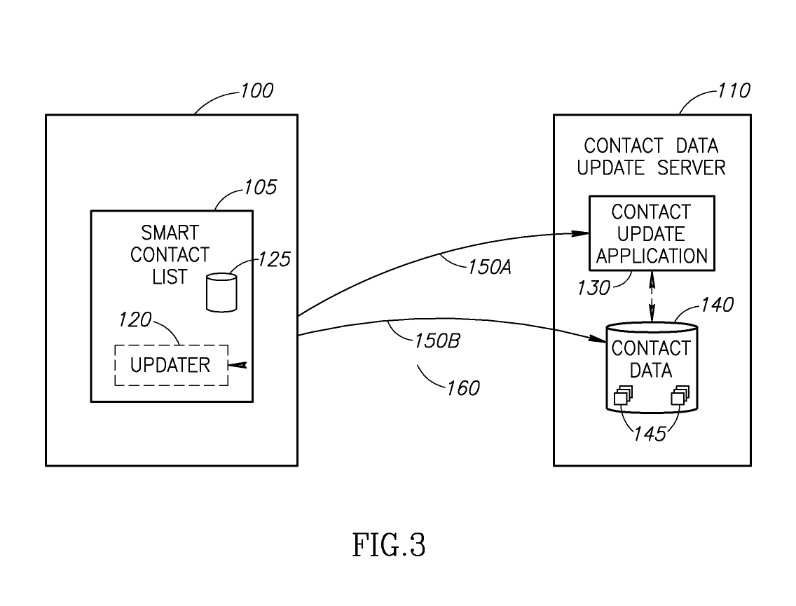

Applicants have realized that it may beneficial to add self updating functionality to contact list 5. FIG. 3, to which reference is now made, shows a smart contact list application 105, constructed and operative in accordance with a preferred embodiment of the present invention. Smart contact list application 105 may be located on mobile communications device 100. Device 100 may communicate with contact data update server 110 via connections 150 and 160.

Smart contact list application 105 may comprise an updater 120 to update the contents of a contact database 125 on an as-needed basis. Alternatively, as will be described hereinbelow, updater 120 may update contact database 125 on a periodic basis as per a defined schedule. Updater 120 may access server 110 via connections 150 to request updates from a contact data database 140 on server 110. Such updates may be downloaded to device 100 via connection 160. It will be appreciated that while updater 120 may be implemented as an internal feature of application 105, it may also be implemented as an external feature that may be authorized to update contact list database 125. Similarly, updater 120 may employ built-in functionality of device 100 to access contact data update server 110, or it may comprise separate means to connect to server 110 via HTTP, TCP or any other suitable protocol.

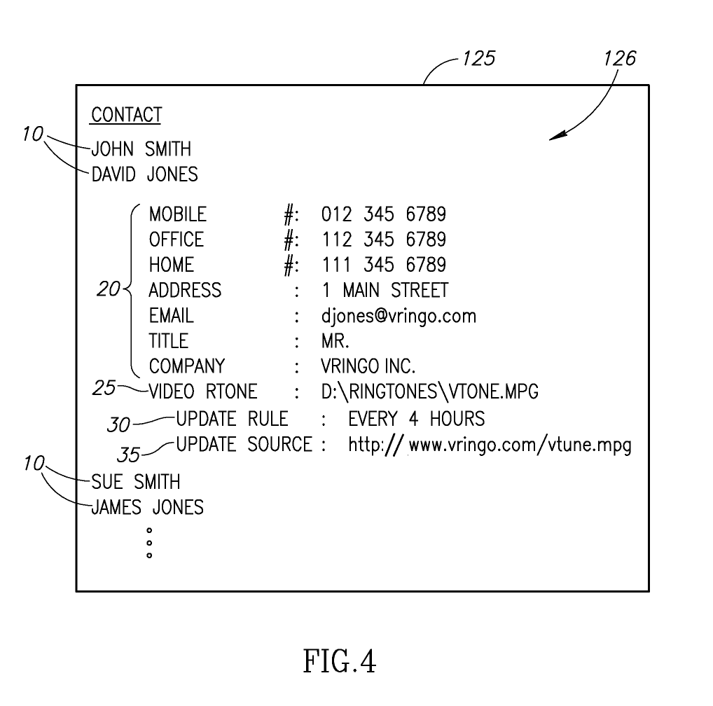

FIG. 4, to which reference is now also made, shows exemplary contact details 126 stored in contact database 125. Each contact detail 126 may represent a field or record in database 125. As in the prior art, for each contact 10 there may be several instances of associated contact data 20, including, for example, phone numbers, a street address, an email address, a title and a company. In accordance with a preferred embodiment of the present invention, there may also be updatable contact data 25, update rule 30 and update source 35.

Updatable contact data 25 may be any suitable contact data associated with contact 10. For example, updatable contact data may be a video ringtone to be played when contact 10 communicates with device 100. Update source 35 may list an indicator for accessing server 110, for example, a URL, or a web services request. For the purposes of illustration, the exemplary embodiments described hereinbelow may refer to this indicator as a URL. It will, however, be appreciated that web services requests and any other suitable means may also be used. Update rule 30 may comprise a rule according to which server 110 may be periodically accessed in order to update updatable contact data 25.

In accordance with an exemplary embodiment of the present invention, as shown in FIG. 4, updatable contact data 25 may be a media ringtone stored on device 100 as D:\ringtones\vtone.mpg. As per an associated update rule 30, in this example, updater 120 may update this media ringtone once every four hours. Associated update source 35 may indicate a URL from which a currently updated media ringtone may be downloaded to device 100 and stored in the location indicated by updatable contact data 25 (replacing a previous version).

Upon startup of device 100, updater 120 may set a timer based on an internal clock on device 100. Every time interval (which is four hours in the example of FIG. 4), updater 120 may initiate a connection, such as connection 150B, to the URL indicated in update source 35 (i.e. an item in contact data database 140 of server 110). Contact data database 140 may store one or more media ringtones 145 to update updatable contact data 25 and a specific media ringtone 145 may be indicated by the URL listed in update source 35. Updater 120 may download this media ringtone 145 via connection 160 and may then save it in place of the previous media ringtone indicated by updatable contact data 25.

It will be appreciated that update source 35 may not always indicate a specific media ringtone 145 to download. In accordance with an alternative preferred embodiment of the present invention, update source 35 may, instead, indicate contact update application 130. Update application 130 may comprise logic to determine an appropriate media ringtone 145 to download to device 100. Updater 120 may connect to contact update application 130 via connection 150A instead of directly accessing a media ringtone 145 via connection 150B.

Updater may provide application 130 with identifying parameters to determine which media ringtone 145 to download. For example, updater 120 may provide application 130 with phone numbers for both contact 10 and device 100 in order to determine an appropriate media ringtone 145. Updater 120 may also provide application 130 with a context parameter. For example, different media ringtones 145 may be used for different events, such as incoming, outgoing and/or the ending of calls. The context parameter may be used by application 130 to specify which media ringtone 145 may be appropriate to download for a given context. It will be appreciated that the use of phone numbers to identify contact 10 and device 100 may be exemplary; any available data that may uniquely identify contact 10 and/or a user of device 100 may be suitable.

It will be appreciated that the update interval may not be constant. Updater 120 may apply predefined logic to determine a desired interval. The user of device 100 may specify an interval. Server 110 may supply a “next interval” or “next connection time” value each time updater 120 requests an update. This value may determine the next time that updater 120 requests an update.

It will be appreciated that the use of a media ringtone as updatable contact data 25 is exemplary; any individual associated contact data 20 may be defined as updatable contact data 25. It will further be appreciated that updatable contact data 25 may be not be restricted to existing examples of associated contact data; additional updatable contact data may be defined and implemented as needed within the context of smart contact list 105.

U.S. patent application Ser. No. 11/544,938, assigned to the common assignees of the present invention and hereby incorporated in its entirety by reference, discloses a community server for the distribution of shared media content as video ringtones. A user may typically share a media ringtone with a friend or “buddy” by selecting a media ringtone on the community server. The media ringtone may then be downloaded to a buddy's device 100. In accordance with a preferred embodiment of the present invention, server 110 may comprise the functionality of a community server as disclosed by U.S. patent application Ser. No. 11/544,938.

U.S. patent application Ser. No. 11/544,938 also discloses a personal content manager to be implemented on a mobile communications device such as device 100. The personal content manager may use published APIs and/or other means to play media ringtones at least before or after call related activity on device 100. However, the implementation of the personal content manager may be problematic on some devices 100. Mobile communications devices may typically assign high priority to phone application 50, thereby making it difficult for a personal content manager to reliably intercept incoming and outgoing calls in order to play a particular media ringtone.

Accordingly, it will be appreciated that implementing smart contact list 105 may obviate the need for a personal content manager. Smart contact list 105 may comprise the logic required to associate specific media ringtones with specific contacts 10 and/or specific triggering events such as incoming, outgoing and ending calls. It may therefore be possible to implement the system disclosed in U.S. patent application Ser. No. 11/544,938 without a client application on device 100.

The system disclosed in U.S. patent application Ser. No. 11/544,938 typically caches media ringtones on device 100 in order to avoid a delay when playing them. On a device 100 with a high speed connection, for example a WiFi phone, it may be possible to download or stream a media ringtone as needed. It may therefore not be necessary to cache a copy of the media ringtone in advance. In accordance with an alternative preferred embodiment of the present invention, updatable contact data 25 may indicate a URL for a media ringtone 145 that may be accessed directly as needed for streaming/downloading without pre-caching.

In accordance with another preferred embodiment of the present invention, updatable contact data 25 and/or update source 35 may comprise a URL for an RSS (Really Simple Syndication) feed. RSS feeds may typically be used for news, blogs, and other often-changing data sources. They may change the material (either a text article or a media clip) at the URL whenever there may be a new item. In accordance with a preferred embodiment of the present invention, the RSS feed may be of media clips. Thus, the media clip shown to a user and/or his buddy may be one of the current RSS media clips. The clip may not be the most current RSS media clip, for example, when the feed may have been updated after the contact list application most recently downloaded from the URL.

In accordance with an alternative preferred embodiment of the present invention, update rule 30 and/or update source 35 may not be associated with a specific contact 10. Instead, update rule 30 and/or update source 35 may be defined for all of contacts 10. It will be appreciated that update rule 30 and update source 35 may also be defined for groups of contacts 10 as well. Accordingly updater 120 may update a multiplicity of contacts 10 from a single update source 35 according to a single update rule 30.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An application for a mobile communications device, the application comprising:
a contact list application to provide contact list operations for contact details of at least one contact, wherein said contact details comprise at least one instance of updatable contact data associated with said at least one contact; and
an updater to update said updatable contact data from an external update source specified in said updatable contact data.

2. The application according to claim 1 and wherein said contact details comprise at least one indication of said update source.

3. The application according to claim 2 and wherein said indication is a uniform resource locator (URL).

4. The application according to claim 2 and wherein said indication indicates a web services request.

5. The application according to claim 2 and wherein said indication points to an updated version of said updatable contact data.

6. The application according to claim 2 and wherein said indication points to a contact update application to determine an appropriate new version of said updatable contact data to download to said mobile device.

7. The application according to claim 2 and wherein said updater comprises means to send identifying parameters to said contact update application.

8. The application according to claim 7 and wherein said identifying parameters comprise at least one indicator of said contact and a user of said device.

9. The application according to claim 7 and wherein said identifying parameters comprise at least one indicator of event context.

10. The application according to claim 2 and wherein said update source is associated with at least one of: said contact, a group of said contacts, and all of said contacts in said contact list.

11. The application according to claim 1 and wherein said updater also comprises an update rule checker to check an update rule of each said contact detail, wherein said update rule indicates when to update said at least one updatable item.

12. The application according to claim 11 and wherein said update rule is associated with at least one of: said contact, a group of said contacts, and all of said contacts in said contact list.

13. The application according to claim 2 and wherein said indication indicates an RSS (Really Simple Syndication) feed.

14. The application according to claim 1 and wherein said updatable contact data is shared media content selected by a buddy of a user of said device, wherein said at least one contact represents said buddy.

15. A contact list update method comprising:
for each contact having an updatable contact detail, accessing an update source specified in said updatable contact detail;
receiving at least one of said updated versions from said update source; and
assigning said updated version to said contact.

16. The method according to claim 15 and wherein said update source is associated with a specific contact.

17. The method according to claim 15 and wherein said update source is associated with at least one of: a group of contacts and all contacts in said contact list.

18. The method according to claim 15 and wherein said update source is associated with a specific event context.

19. The method according to claim 15 and also comprising:
providing an update rule to determine a periodicity for said accessing.

20. The method according to claim 19 and wherein said providing is associated with a specific contact.

21. The method according to claim 20 and wherein said providing is associated with at least one of: a group of contacts and all contacts in said contact list.

22. The method according to claim 15 and wherein said update rule is associated with a specific event context.

23. The method according to claim 15 and wherein said accessing comprises:
accessing a URL for said update source.

24. The method according to claim 15 and wherein said accessing comprises:
activating a web services request for said update source.

25. The method according to claim 15 and wherein said accessing comprises:
accessing an RSS feed for said update source.

26. A mobile communication device comprising:
a contact list application at least to display a media clip upon communication with an entity listed as part of the contact details of a contact; and
an updater to update said media clip from an external update source specified as part of said contact details.

27. The device according to claim 26 and wherein said external update source is a community server to enable a buddy of a user of said device to select shared media content for said user, wherein said at least one contact represents said buddy.

28. The device according to claim 26 and wherein said updater also comprises an update rule checker to check an update rule for each said contact, wherein said update rule indicates when to update said media clip.
